(19) United States
(12) Patent Application Publication
(10) Pub. No.: US 2026/0111646 A1
(43) Pub. Date: Apr. 23, 2026

(54) SYSTEMS AND METHODS FOR MULTI-MODAL CONTENT DELIVERY

(71) Applicant: ADAPTIVE READER INC., Cambridge, MA (US)

(72) Inventors: Ethan PIERCE, Cambridge, MA (US); Eric CARLSTROM, Arlington, MA (US); Noah Yeates BRINTON, Providence, RI (US); Corey Evan CLEMENTE, Melrose, MA (US)

(73) Assignee: ADAPTIVE READER INC., Cambridge, MA (US)

(21) Appl. No.: 19/365,260

(22) Filed: Oct. 22, 2025

Related U.S. Application Data
(60) Provisional application No. 63/710,531, filed on Oct. 22, 2024.
(60) Provisional application No. 63/843,395, filed on Jul. 14, 2025.

(51) Int. Cl. G06F 40/103; G06F 3/16; G06F 9/451; G06F 21/62

(52) U.S. Cl. CPC G06F 40/103; G06F 3/165; G06F 9/454; G06F 21/6218

(57) ABSTRACT

Systems and methods for multi-modal content delivery. In some embodiments, a request for content is received from a user device. The request may include information indicative of a per-copy identifier associated with a copy of a piece of content. One or more features may be determined based on the per-copy identifier associated with the copy of the piece of content, and may be enabled in a user interface presented by the user device. Additionally, or alternatively, the request may include information indicative of a passage identifier associated with a passage of a plurality of passages in a piece of writing. The passage identifier may be used to obtain text associated with the passage, and the text may be rendered in a user interface presented by the user device.

### RELATED APPLICATIONS

This application claims priority under 35 U.S.C. § 119(e) to U.S. provisional patent application, U.S. Ser. No. 63/843,395, filed Jul. 14, 2025; and U.S. provisional patent application, U.S. Ser. No. 63/710,531, filed Oct. 22, 2024, both of which are herein incorporated by reference in their entirety.

### BACKGROUND

Books have been published in more or less the same way for centuries. Initially, a title may be released in a language in which it is written. As the title's popularity rises, it may be translated into one or more other languages. Moreover, corrections and/or other changes may be made after initial publication. Such changes may be batched into new editions that are released from time to time.

More recently, many books are published in multiple formats. For instance, in addition to a print format, a title may be released in an electronic text format, an audio format, etc.

### SUMMARY

In accordance with some embodiments, a method is provided, comprising acts of: receiving, from a user device, a request for content, the request comprising information indicative of a per-copy identifier associated with a copy of a piece of content; determining, based on the per-copy identifier associated with the copy of the piece of content, one or more features; and causing the one or more features determined based on the per-copy identifier to be enabled in a user interface presented by the user device.

In accordance with some embodiments, a method is provided, comprising acts of: receiving, from a user device, a request for content, the request comprising information indicative of a passage identifier associated with a passage of a plurality of passages in a piece of writing; using the passage identifier to obtain text associated with the passage; and causing the text to be rendered in a user interface presented by the user device.

In accordance with some embodiments, a system is provided that is configured to perform any of the methods described herein. For instance, the system may comprise at least one processor and at least one computer-readable storage medium having stored thereon instructions which, when executed, program the at least one processor to perform any of the methods described herein.

In accordance with some embodiments, at least one computer-readable storage medium is provided, having stored thereon instructions which, when executed, program at least one processor to perform any of the computer-implemented methods described herein.

### BRIEF DESCRIPTION OF DRAWINGS

FIG. 1 shows an illustrative content delivery platform 100, in accordance with some embodiments.

FIG. 2A shows an illustrative cover 200 of a book, in accordance with some embodiments.

FIG. 2B shows an illustrative internal page 210 of a book, in accordance with some embodiments.

FIG. 3 shows an illustrative content delivery interface 300, in accordance with some embodiments.

FIG. 4 shows an illustrative print edition 400 of a piece of content, in accordance with some embodiments.

FIG. 5 shows an illustrative content delivery interface 500, in accordance with some embodiments.

FIG. 6 shows an illustrative data structure 600, in accordance with some embodiments.

FIG. 7 shows an illustrative input text 700 and an illustrative output transcript 705, in accordance with some embodiments.

FIG. 8A shows an illustrative process 800 for providing access to content, in accordance with some embodiments.

FIGS. 8B and 8C show, respectively, illustrative covers 830 and 840, in accordance with some embodiments.

FIG. 8D shows an illustrative content delivery interface 850, in accordance with some embodiments.

FIG. 9 shows an illustrative process 900 for generating a new edition of a piece of content, in accordance with some embodiments.

FIG. 10 shows, schematically, an illustrative computer 10000 on which any aspect of the present disclosure may be implemented.

### DETAILED DESCRIPTION

Aspects of the present disclosure relate to systems and methods for multi-modal content delivery. Any suitable content may be delivered, such as books, songs, movies, training materials, etc. Such content may be delivered in any suitable modality, for example, in any suitable format (e.g., print, electronic text, audio, video, etc.), language (e.g., English, Spanish, American Sign Language, etc.), dialect (e.g., American English, British English, Mexican Spanish, Castilian Spanish, Canadian French, Metropolitan French, etc.), reading level (e.g., according to a standard such as Guided Reading Levels, Developmental Reading Assessment, Lexile, etc.), etc. A print format may be visual or tactile (e.g., in ink or Braille), and likewise for an electronic text format (e.g., to be rendered on a visual display or a Braille display).

The inventors have recognized and appreciated that, while a piece of content may be available in multiple modalities, there may be no easy way to synchronize the content across the different modalities. As an example, an audio book may include chapter markers only. Thus, a dyslexic reader who wishes to listen to a particular passage in a book may not be able to quickly find the right place in an audio edition of the book.

As another example, pagination may be altered when a book is translated into a different language. Thus, a second language learner who wishes to see a translation of a particular passage in a book may not be able to quickly find the right place in a translated edition of the book.

As yet another example, pagination may be altered when a book is formatted differently (e.g., using a different layout, font size, etc.). Thus, a student with impaired vision who is using a special edition of a book may not be able to quickly find the right place when a teacher references a particular passage using a page number in a regular edition.

This inability to cross reference may create challenges in many settings. For instance, when a teacher asks all students in a classroom to turn to a particular page for in-depth discussion, students with special needs (e.g., those who are dyslexic or need second language support) may be unable to follow along.

Accordingly, in some embodiments, techniques are provided for synchronizing content across different modalities. For instance, a piece of content may be segmented into a plurality of passages. Each passage may be associated with a unique identifier, which may be used to access the passage across different modalities.

The inventors have further recognized and appreciated that it may be desirable to provide content personalization in a manner that preserves privacy. For example, it may be desirable to allow a student to create a personalized edition of a book (e.g., in a selected language and/or at a selected reading level) without collecting personal information from the student. This may facilitate compliance with privacy laws and regulations, such as the Children's Online Privacy Protection Act (COPPA).

Accordingly, in some embodiments, each copy of a piece of content may be associated with a unique identifier, which may be used to index personalized content. For instance, an identifier that is unique to a physical copy of a book may be embedded in a code printed in the book. A user may scan the code (e.g., using a mobile device) to launch a web application, or otherwise provide the unique identifier as input to the web application. The web application may use the unique identifier to track the user's activities (e.g., notes taken by the user, creation of a personalized edition, etc.) without collecting any personal information.

Additionally, or alternatively, the web application may use the unique identifier to determine whether to enable one or more features. For instance, a teacher may, for each student, record the unique identifier for a particular copy of a book given to that student. If the student has a learning disability, the teacher may use an administrator interface of the web application to enable one or more features for the unique identifier, for example, according to an Individualized Education Program (IEP) for the student. Otherwise, the one or more features may remain disabled by default. In this manner, the web application may provide a personalized experience for the student without collecting any personal information.

It should be appreciated that the techniques disclosed herein may be implemented in numerous ways, as such techniques are not limited to any particular manner of implementation. Examples of implementation details are provided herein solely for purposes of illustration. Furthermore, the techniques disclosed herein may be used individually or in any suitable combination, as aspects of the present disclosure are not limited to any particular technique or combination of techniques.

For instance, while examples are provided throughout with a visual display and mouse navigation, the techniques disclosed herein may also be used with a non-visual display (e.g., a screen reader) and/or keyboard navigation.

It should also be appreciated that, while examples in an education setting are provided throughout, the techniques disclosed herein may be used in other settings, as well. For instance, any suitable combination of such techniques may be used for corporate training, content publishing, etc.

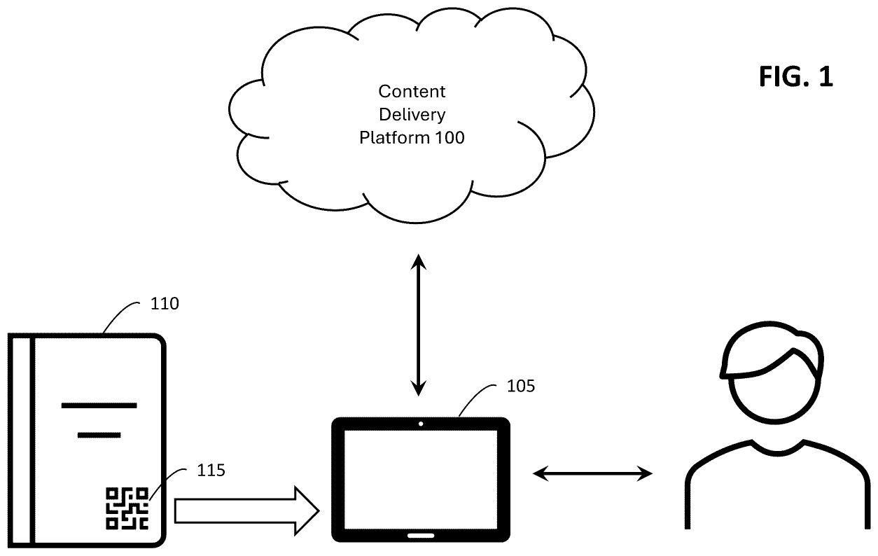

FIG. 1 shows an illustrative content delivery platform 100, in accordance with some embodiments. The content delivery platform 100 may run on one or more remote devices, such as one or more cloud computing servers.

A user may interact with the content delivery platform 100 in any suitable manner. For instance, the user may interact with the content delivery platform 100 via a web browser running on a user device 105, which may be a desktop, a workstation, a mobile device (e.g., a laptop, a tablet, a smartphone, etc.), etc. The web browser may execute one or more software scripts (e.g., in JavaScript) received from the content delivery platform 100. Additionally, or alternatively, the user may interact with stand-alone software installed on the user device 105, where the stand-alone software may be configured to communicate with the content delivery platform 100 via one or more remote application programming interfaces (APIs).

In some embodiments, one or more functionalities may be distributed in a suitable manner among the user device 105, the content delivery platform 100, and/or one or more other systems. As an example, software running on the user device 105 (e.g., a web browser executing a script, or stand-alone software) may convert a speech prompt spoken by the user into text, and may transmit such text to the content delivery platform 100. In response, the content delivery platform 100 may use the received text to invoke an artificial intelligence (AI) system that is configured to search for, generate, and/or adapt content.

In some instances, the user may be in possession of a copy of a piece of content. As an example, the user may have a copy of a print edition of a book (e.g., a hardcover, paperback, or looseleaf copy). This may be referred to herein as a hard copy. As another example, the user may have a copy of an electronic text edition of a book (e.g., an electronic file in plain text, Portable Document Format (PDF), or another suitable format). This may be referred to herein as an electronic text copy.

In some embodiments, a copy of a piece of content may include a code having some suitable information embedded therein. For instance, the code may indicate a title, a volume, an edition, a version, a language, a dialect, a reading level, a culture, an author, a copyright date, etc.

Additionally, or alternatively, the code may indicate a batch identifier. For example, a school may order multiple copies of a book to be distributed to students in one or more classes. Such copies may have the same batch identifier, which may be associated with the order placed by the school.

Additionally, or alternatively, the code may indicate an identifier associated with that particular copy of the content.

It should be appreciated that aspects of the present disclosure are not limited to the use of a code having relevant information embedded therein. In some embodiments, a code included in a copy of a piece of content may be used by the content delivery platform 100 to access relevant information (e.g., by looking up a database entry associated with the code).

In some embodiments, a code may be represented as an optical pattern, such as a quick response (QR) code. For instance, in the example of FIG. 1, the user is in possession of a hard copy 110 of a book, and a QR code 115 is printed on a cover of the hard copy 110 (or on a label that is affixed to the cover). However, it should be appreciated that aspects of the present disclosure are not so limited. In some embodiments, the user may be in possession of an electronic text copy of the book, instead of, or in addition to, the hard copy 110. The code may appear on any suitable page of the electronic text copy.

In some embodiments, the user may use the user device 105 to scan the QR code 115. For instance, the user device 105 may have a camera application configured to recognize and decode QR codes. The QR code 115 may be configured to, upon scanning, cause the user device 105 to launch a web browser with a Uniform Resource Locator (URL) of a web application hosted by the content delivery platform 110. Additionally, or alternatively, the QR code 115 may be configured to, upon scanning, cause the user device 105 to launch standalone software configured to communicate with the content delivery platform 100 via one or more remote APIs.

It should be appreciated that aspects of the present disclosure are not limited to representing a code in any particular manner. In some embodiments, a code may be represented as an alphanumeric string printed on the hard copy 110 (or on a label that is affixed to the hard copy 110). The user may enter the alphanumeric string into the web application or the standalone software. Additionally, or alternatively, a code may be represented as a radio frequency identification (RFID) tag affixed to the hard copy 110. The user device 105 may include an RFID reader, such as a near field communication (NFC) transceiver, that is configured to read the RFID tag.

It should also be appreciated that aspects of the present disclosure are not limited to any particular placement for a code. In the example of FIG. 1, the QR code 115 is located on a front portion of the cover of the hard copy 110.

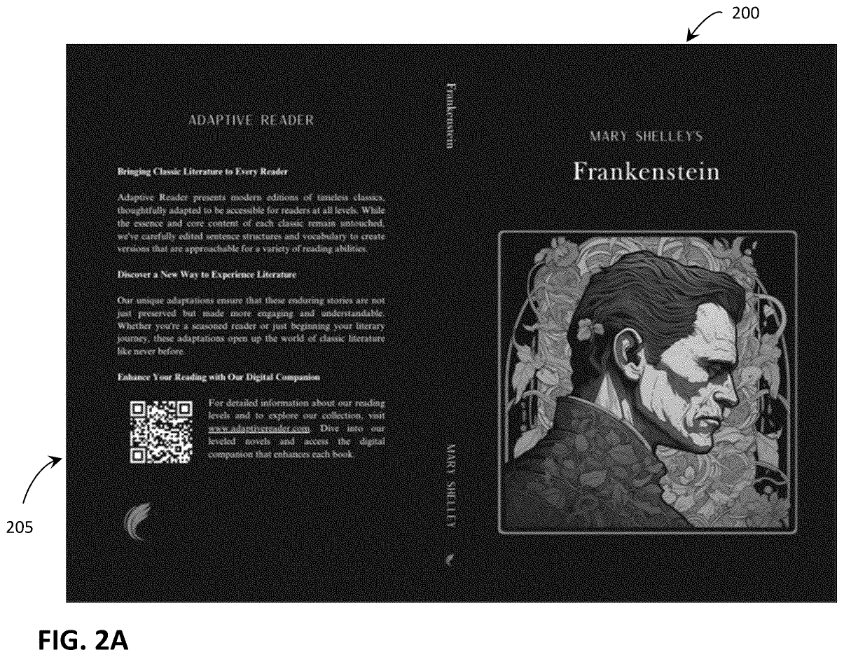

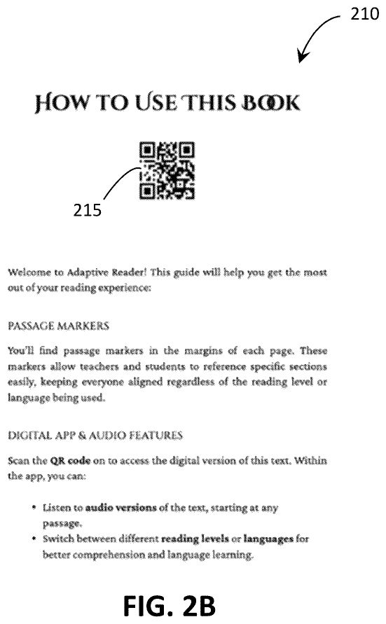

FIG. 2A shows an illustrative cover 200 of a book, in accordance with some embodiments. A QR code 205 is located on a back portion of the cover 200.

FIG. 2B shows an illustrative internal page 210 of a book, in accordance with some embodiments. A QR code 215 is located on the internal page 210.

In some embodiments, selected content may be delivered in response to a request associated with a code. For instance, the illustrative content delivery platform 100 in the example of FIG. 1 may deliver an adapted edition of the book in response to the user scanning the QR code 115. The adapted edition may be a translation into a selected language or dialect, an adaptation for a selected reading level or culture, etc. Additionally, or alternatively, the content delivery platform 100 may deliver an audio edition of the book in response to the user scanning the QR code 115.

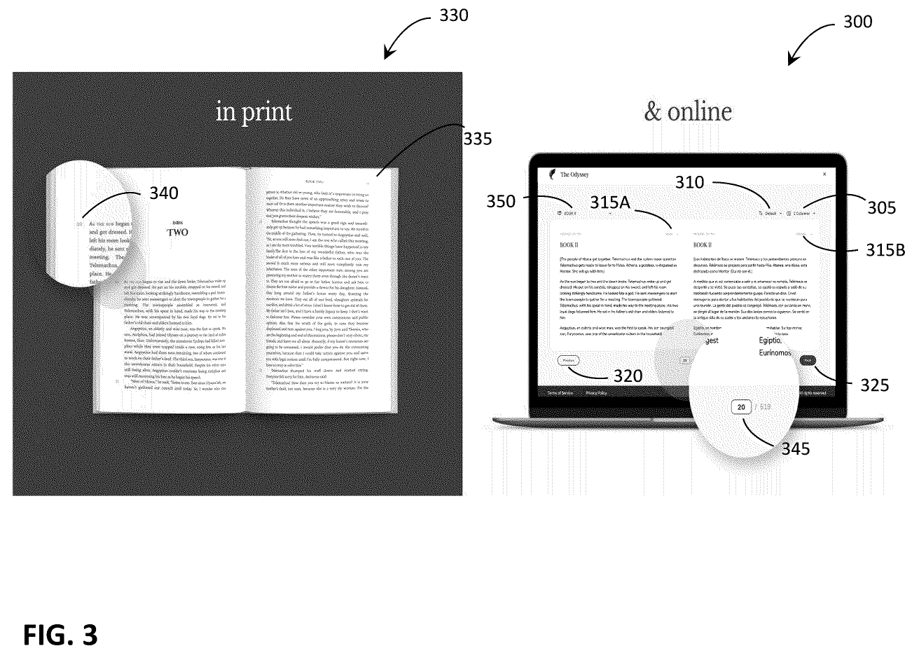

FIG. 3 shows an illustrative content delivery interface 300, in accordance with some embodiments. For instance, the content delivery interface 300 may be presented by the illustrative content delivery platform 100 in the example of FIG. 1 in response to the user scanning the illustrative QR code 115. This may be done in any suitable manner, for example, via a web browser or standalone software on the illustrative user device 105.

In some embodiments, the content delivery interface 300 may have a layout that is configurable. For instance, the content delivery interface 300 may include a menu 305 configured to allow the user to select a desired layout, such as a layout having a plurality of panes arranged in a desired manner (e.g., top to bottom, left to right, layered and tabbed, etc.).

Additionally, or alternatively, the content delivery interface 300 may include a menu 310 configured to allow the user to select a desired font size. For instance, a user who is visually impaired may be able to select a larger font size.

It should be appreciated that aspects of the present disclosure are not limited to a content delivery interface that is configurable in any particular manner, or at all. In some embodiments, the content delivery interface 300 may allow the user to select one or more color filters, such as color inversion, color differentiation (e.g., for color blindness), etc. Additionally, or alternatively, the content delivery interface 300 may allow the user to activate a decode mode, which may display, in a differentiated manner, portions of a selected word that correspond, respectively, to different phonemes. This may assist the user in decoding the word.

Referring again to the example of FIG. 3, the user has selected a two-column layout. The two panes may be separately configured to display selected editions of the same content. For instance, the left pane may include a menu 315A configured to allow the user to select from an original edition and/or one or more adapted editions into different reading level(s), whereas the right pane may include a menu 315B configured to allow the user to select from an original edition and/or one or more adapted editions into different language(s).

For instance, the user may select a Silver edition via the menu 315A. The Silver edition may be obtained from an original edition by reducing complexity by 4-6 grade levels. Although not shown in FIG. 3, there may be a Gold edition, which may represent a reduction of 2-3 grade levels, and/or a Bronze edition, which may represent a reduction to a second-grade reading level.

In some embodiments, content displayed in the left pane and content displayed in the right pane may correspond to each other. For instance, in the example of FIG. 3, the user has selected a Silver edition for the left pane and a Spanish edition for the right pane. A passage displayed in the left pane may be adapted (by reducing complexity) from a certain passage in an original edition, and a passage displayed in the right pane may be adapted (by translating into Spanish) from the same passage in the original edition.

It should be appreciated that aspects of the present disclosure are not limited to displaying multiple adapted editions. In some embodiments, an original edition may be selected for the left pane, while an adapted edition is selected for the right pane, or vice versa. Accordingly, a passage displayed in the right pane may be adapted from a passage displayed in the left pane, or vice versa.

In some embodiments, content displayed in the left pane and content displayed in the right pane may be synchronized. For instance, in the example of FIG. 3, the content delivery interface 300 includes a Previous button 320 and a Next button 325. By clicking the Previous button 320, the user may cause the left and right panes to be updated simultaneously. The left pane may be updated to display a previous passage in the Silver edition, while the right display may be updated to display a previous passage in the Spanish edition. The previous passage in the Silver edition may correspond to the previous passage in the Spanish edition. For instance, both may be adapted from a previous passage in the original edition.

It should be appreciated that an original edition from which adaptations are made may not be an original as written by an author. For instance, the Odyssey was originally written in Homeric Greek, but a suitable English translation (e.g., selected by a teacher for a literature class) may be used as an original edition.

In some embodiments, a passage may include a meaningful portion of text, such as a portion of text relating to one or more topics. Such passages may be obtained in any suitable manner. For instance, one or more suitable text segmentation techniques may be used to divide a piece of writing (e.g., a book, an essay, an article, etc.) into passages.

A passage may have any suitable length. For instance, a passage may consist of a single sentence, several sentences, a single paragraph, several paragraphs, etc. Moreover, different passages in the same piece of writing may have different lengths.

The inventors have recognized and appreciated that passages may be more suitable than pages as units for synchronizing content. For instance, a page break in an original edition may occur midway through a sentence. It may be challenging to identify a corresponding point in an adapted edition.

Moreover, page breaks may not coincide with topic transitions. For instance, a page may begin or end in the middle of a discussion relating to a certain topic. To fully comprehend the topic, the user may have to go back and forth between two pages, which may be inconvenient.

Accordingly, in some embodiments, the illustrative content delivery platform 100 in the example of FIG. 1 may be configured to first segment an original edition of a piece of content into passages, and then adapt the individual passages (e.g., into one or more languages, dialects, reading levels, cultures, etc.)

The inventors have further recognized and appreciated that, in some instances (e.g., in a classroom setting), it may be desirable to synchronize between a print edition and one or more electronic editions (e.g., electronic text, audio, video, etc.).

Accordingly, in some embodiments, a print edition may be provided that includes passage identifiers in addition to, or instead of, page identifiers. For instance, a print edition may include a page number printed on each of a plurality of pages, as well as a passage number printed in association with each of a plurality of passages (e.g., at a suitable location to indicate such association). Thus, there may be at most one page number on a page. By contrast, in some instances, there may be multiple passage numbers on a page.

Referring again to the example of FIG. 3, a page number 335 is printed at the top right corner of an odd-numbered page in a print edition 330. (Although not shown, a page number may be printed at the top left corner of an even-numbered page.) By contrast, a passage number 340 may be printed in the left margin at the beginning of a corresponding passage in the print edition 330. However, it should be appreciated that aspects of present disclosure are not limited to any particular placement of a page number or a passage number. For instance, a page number may be printed at any suitable location on a page, such as the middle of the top margin or the bottom margin. Additionally, or alternatively, a passage number may be printed in any suitable manner to indicate an association with a corresponding passage (e.g., in the right margin at the beginning of the passage, or at the end of the passage).

In some embodiments, the content delivery interface 300 may allow the user to navigate to a selected passage in one or more electronic editions. For instance, the content delivery interface 300 may include an input field 345. If the user is reading a selected passage in the print edition 330, and wishes to review corresponding passage(s) in the Silver edition and/or the Spanish edition, the user may locate a passage number in the left margin at the beginning of the selected passage in the print edition 330, and enter the passage number into the input field 345. This may cause the left pane and the right pane to update simultaneously to the corresponding passages in the Silver edition and the Spanish edition, respectively.

It should be appreciated that aspects of the present disclosure are not limited to synchronizing a print edition with any particular number of electronic edition(s), or at all. In some instances, the user may configure the content delivery interface 300 to display only one electronic text edition.

Furthermore, aspects of the present disclosure are not limited to navigating through content in any particular manner. For instance, in the example of FIG. 3, the content delivery interface 300 includes a menu 350 configured to allow the user to select a desired unit of content (e.g., a certain volume, part, chapter, section, etc.).

Additionally, or alternatively, a scannable code (e.g., a QR code) may be provided for each passage in a print edition, in addition to, or instead of, a passage number. The scannable code may be used to navigate to a corresponding passage in a different edition (e.g., an electronic text edition, an audio edition, a video edition, etc.). For instance, the scannable code may encode the passage number, or other information that may be used to obtain the passage number.

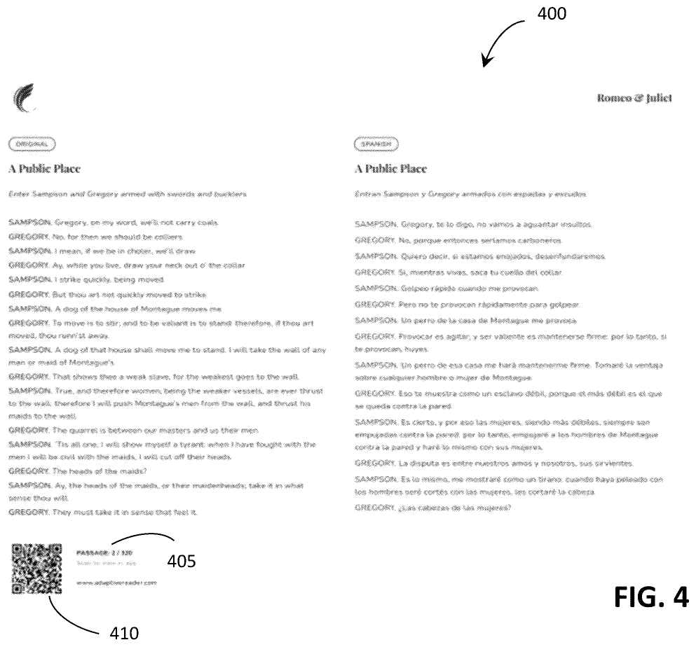

FIG. 4 shows an illustrative print edition 400 of a piece of content, in accordance with some embodiments. In this example, the print edition 400 is in a two-column format. An original edition of the content may be printed on the left, while a Spanish edition of the content may be printed on the right. This may allow comparative reading, which may facilitate comprehension for second language learners.

It should be appreciated that aspects of the present disclosure are not limited to printing an original edition and an adapted edition side by side. In some embodiments, two different adapted editions (e.g., the Silver and Spanish editions in the example of FIG. 3) may be printed side by side, or just one adapted edition may be printed in a single column format.

In some embodiments, a piece of content may be segmented so that each passage and/or a corresponding adapted passage may fit on one page. In this manner, a user may view an entire passage and/or a corresponding adapted passage without paging back and forth, which may facilitate comprehension.

For instance, a length limit (e.g., a number of lines, words, characters, etc.) may be used as a constraint when segmenting the content, so that each resulting passage may fit on one page, half a page, or any suitable space. Additionally, or alternatively, a similar length limit may be used as a constraint when adapting passages (e.g., into one or more languages, dialects, reading levels, cultures, etc.), so that each resulting adapted passage may fit on one page, half a page, or any suitable space.

Referring again to the example of FIG. 4, a passage number 405 and a QR code 410 are printed at the end of the passage in the original edition (hereafter, the original passage). The QR code 410 may encode the passage number 405, in addition to other information (e.g., title, volume, edition, version, language, dialect, reading level, culture, author, copyright date, batch identifier, copy identifier, etc.).

The user may use the illustrative user device 105 in the example of FIG. 1 to scan the QR code 410. This may cause the illustrative content delivery platform 100 in the example of FIG. 1 to display the original passage and/or a corresponding passage in a selected edition via the illustrative content delivery interface 300 in the example of FIG. 3.

In this manner, the user may be able to access the original passage directly, without having to scan a QR code printed on a cover of the print edition 400 or manually enter the passage number 405. However, it should be appreciated that aspects of the present disclosure are not limited to providing a scannable code for each passage, or any scannable code at all.

In some embodiments, the content delivery interface 300 may allow the user to take an image of a portion of text in the print edition 400 (e.g., using a camera application of the user device 105). The content delivery interface 300 may convert the image to text, and send the text to the content delivery platform 100. Additionally, or alternatively, the content delivery interface 300 may send the image itself. The content delivery platform 100 may process the text and/or the image to identify a passage to which the text belongs, and may cause the content delivery interface 300 to display the identified passage. (If the text straddles multiple passages, the earlier/earliest passage may be displayed.)

Furthermore, aspects of the present disclosure are not limited to the use of a scannable code that directly encodes relevant information about a passage. In some embodiments, the QR code 410 may encode information that may be used by the content delivery platform 100 to obtain such information (e.g., by accessing a storage location, or looking up a database entry, associated with the passage).

Further still, aspects of the present disclosure are not limited to having per-passage scannable codes in a print edition. In some embodiments, per-passage scannable codes may be provided in an electronic text edition.

The inventors have recognized and appreciated that, when a user with a learning disability such as dyslexia encounters a difficult passage in a piece of content, it may be helpful to allow the user to hear the passage read aloud. Accordingly, in some embodiments, techniques are provided for synchronizing an audio edition with a print edition and/or one or more electronic text editions.

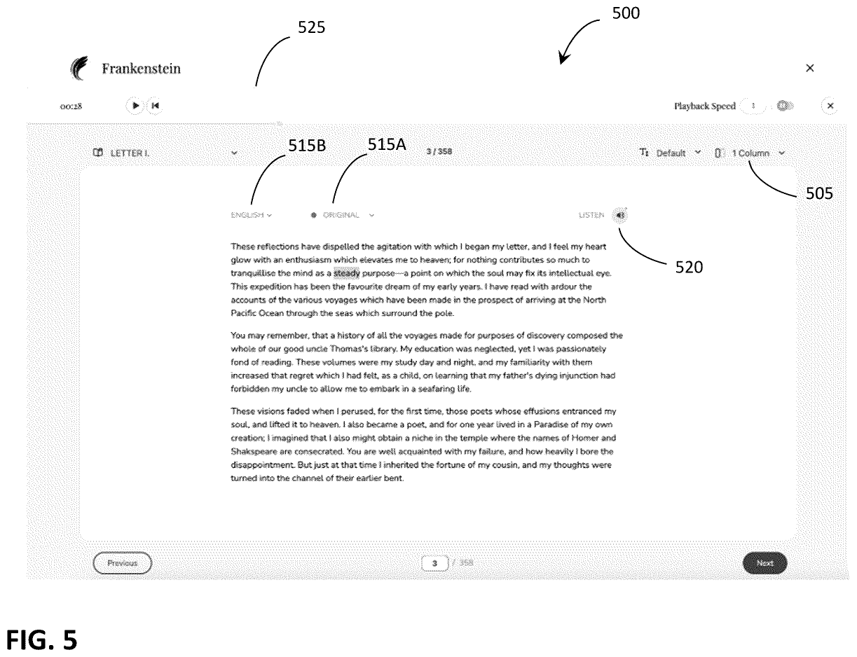

FIG. 5 shows an illustrative content delivery interface 500, in accordance with some embodiments. The content delivery interface 500 may be similar to the illustrative content delivery interface 300 in the example of FIG. 3. For instance, the content delivery interface 500 may be presented by the illustrative content delivery platform 100 in response to the user scanning the illustrative QR code 115 in the example of FIG. 1 or the illustrative QR code 410 in the example of FIG. 4. This may be done in any suitable manner, for example, via a web browser or standalone software on the illustrative user device 105.

In the example of FIG. 5, the user has selected a single column layout via a menu 505, which may be similar to the illustrative menu 305 in the example of FIG. 3. Accordingly, there may be a single pane displaying an edition selected by the user. For instance, a menu 515A may be configured to allow the user to select from one or more reading levels (which may include a reading level of an original edition), while a menu 515B may be configured to allow the user to select from one or more languages (which may include a language of the original edition).

In some embodiments, given a selected reading level and a selected language different from those of the original edition, the content delivery platform 100 may first adapt an original passage into the selected reading level, and then translate a resulting adaptation into the selected language. However, it should be appreciated that aspects of the present disclosure are not so limited. In some embodiments, the content delivery platform 100 may perform translation before adaptation for reading level, or may perform both adaptations simultaneously.

Referring again to the example of FIG. 5, the content delivery interface 500 includes a Listen button 520 and a playback control 525. By clicking the Listen button 520, the user may cause the content delivery platform 100 to transmit, to the user device 105, audio data for a passage that is currently displayed in the content delivery interface 500. This may be done in any suitable manner, for example, by streaming the audio data or by downloading an audio file.

The playback control 525 may allow the user to play the audio data received from the content delivery platform 100. Any suitable functionality may be provided. For example, the user may be able to pause, rewind, fast forward, select a particular position in the audio data (e.g., using a slider), select a playback speed, enable autoplay, etc.

In some embodiments, while the user is listening to the current passage, the content delivery platform 100 may transmit, to the user device 105, audio data for one or more subsequent passages (e.g., one, two, three, four, five, . . . subsequent passages). This may ensure that the user may continue listening even if there is a network interruption.

Additionally, or alternatively, the content delivery interface 500 may load the audio data for one or more subsequent passages (e.g., one, two, three, four, five, . . . subsequent passages) before the user finishes listening to the current passage. This may allow a smooth transition from the current passage to an immediately following passage.

However, it should be appreciated that aspects of the present disclosure are not limited to transmitting or loading audio data ahead of time.

The inventors have recognized and appreciated that, to achieve a fast response and a positive user experience, it may be desirable to generate an audio edition ahead of time. However, if an audio edition is generated for an entire piece of content, it may be challenging to segment the audio edition to match passages of an original edition.

Accordingly, in some embodiments, the content delivery platform 100 may generate audio editions of individual passages in an original edition. For instance, a separate job may be created to convert each passage into speech. Such jobs may be scheduled independently. Thus, the passages may be processed in parallel and/or out of order.

The inventors have recognized and appreciated various advantages of asynchronous processing of passages. For example, multiple passages may be processed simultaneously, thereby improving performance. Moreover, one or more load balancing techniques may be used to dispatch passages to different computing devices to be processed, thereby improving throughput.

However, it should be appreciated that aspects of the present disclosure are not limited to generating an audio edition in any particular manner, or at all. In some embodiments, an audio edition for a selected passage may be generated on demand. For instance, in response to the user clicking the Listen button 520 in the example of FIG. 5, the content delivery platform 100 may call a text-to-speech (TTS) service to generate audio data for a passage currently displayed in the content delivery interface 500.

Additionally, or alternatively, while the user is listening to the current passage, the content delivery platform 100 may call a text-to-speech (TTS) service to generate audio data for one or more subsequent passages (e.g., one, two, three, four, five, ... subsequent passages). Such job(s) may run in the background, and may be completed before the user finishes listening to the current passage. Resulting audio data may be transmitted to the user device 105, and may be loaded by the content delivery interface 500, as described above.

Moreover, any other type of adaptation may be performed in an asynchronous manner, in addition to, or instead of, audio adaptation. For instance, a separate job may be created to adapt each passage in an original edition into a different language, dialect, reading level, culture, etc. Such jobs may be scheduled independently and/or distributed to different computing devices.

In some embodiments, a visual indication may be provided to help the user follow a passage displayed in the content delivery interface 500 while listening to corresponding audio. For instance, at any given moment in time, each word that is being read in the audio maybe highlighted (e.g., the word “steady”), while other words may not be highlighted. Thus, the highlighting may move along the text in synchrony with the audio, which may help the user follow the text.

It should be appreciated that aspects of the present disclosure are not limited to synchronizing textual display with audio playback in any particular manner, or at all. For instance, such synchronization may be done at any suitable level of granularity (e.g., morpheme, word, phrase, clause, sentence, paragraph, etc.).

Although not shown in FIG. 5, the content delivery interface 500 may, in some embodiments, allow the user to select a desired level of granularity. Additionally, or alternatively, the content delivery interface 500 may select a default level of granularity (e.g., based on text complexity). This may be done statically or dynamically. For instance, the content delivery interface 500 may switch from sentence-level synchronization to word-level synchronization when a complex passage is encountered.

Complexity may be measured in any suitable manner. For example, a readability score may be determined for a passage, such as a Flesch-Kincaid Grade Level (FKGL) score, a Simple Measure of Gobbledygook (SMOG) score, a Gunning fog (FOG) score, etc. If the readability score is above a selected threshold corresponding to a level of granularity (e.g., morpheme, word, phrase, clause, sentence, paragraph, etc.), synchronization at that level of granularity may be triggered.

It should also be appreciated that aspects of the present disclosure are not limited to using any particular visual indication to differentiate each portion of text (e.g., morpheme, word, phrase, clause, sentence, paragraph, etc.) being read in the audio from the rest of the text, or any such visual indication at all. In some embodiments, each portion of text being read (hereafter the active text) may be displayed normally, while the rest of the text (hereafter the inactive text) may be grayed out.

Additionally, or alternatively, the active text may be displayed in a selected font, size, color, type (e.g., underline, bold, italic, etc.), etc., while the inactive text may be displayed in a different font, size, color, type, etc. For instance, to assist visually impaired users, a larger font size may be used for the active text.

Additionally, or alternatively, a visual indicator (e.g., a dot, an arrow, a hand pointer, etc.) may be shown near the active text. Thus, the visual indicator may move along the text as the text is being read.

The inventors have recognized and appreciated various challenges in synchronizing textual display with audio playback. For instance, in some embodiments, audio data may be generated using one or more TTS services (e.g., Amazon Polly, OpenAI Whisper, Google Cloud Platform TTS, etc.). For some TTS services, an output audio file may not include any timestamp metadata, while other TTS services may provide sentence-level timestamp metadata, but not word-level timestamp metadata. For those TTS services that do provide word-level timestamp metadata, such timestamp metadata may not be formatted consistently.

Accordingly, in some embodiments, the content delivery platform 100 may be configured to process an output of a TTS service, generate timestamp metadata in a selected format, and/or store the timestamp metadata in a manner that facilitates efficient retrieval. Thus, timestamp metadata may be made available consistently, even if different TTS services are used over time (e.g., due to quality, cost, and/or performance considerations).

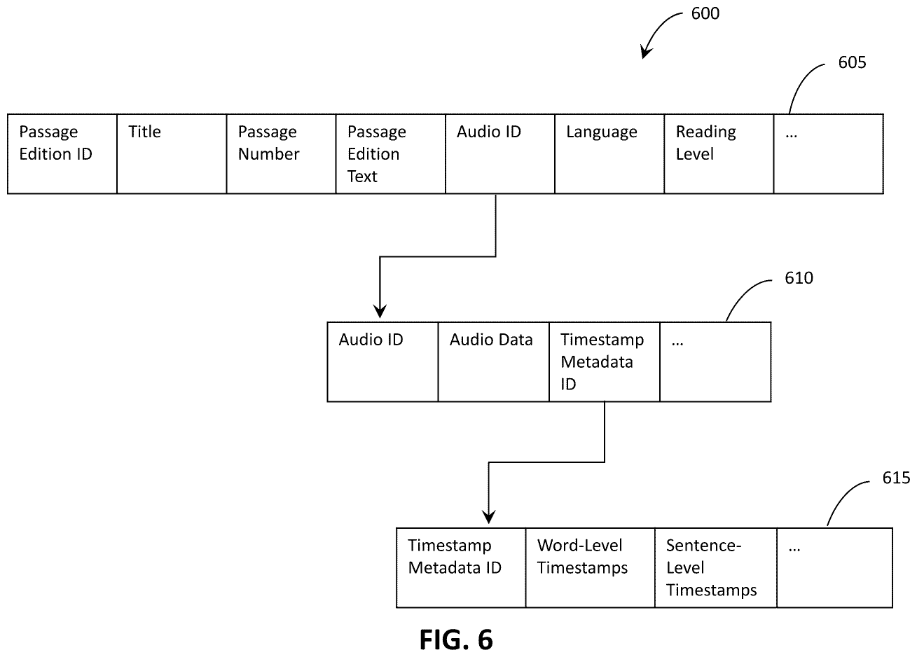

FIG. 6 shows an illustrative data structure 600, in accordance with some embodiments. For instance, the data structure 600 may be used to store data for a certain edition of a passage in a piece of content, which may be an original edition or an adapted edition (e.g., into a certain language, dialect, reading level, culture, etc.).

In some embodiments, the illustrative content delivery platform 100 in the example of FIG. 1 may include a data storage comprising one or more data tables. For instance, there may be a data table storing data for various editions of passages in multiple pieces of content (hereafter, a passage edition table). Such a table may include an entry 605, which may be indexed by a passage edition identifier (ID).

A passage edition ID may be assigned to each edition of each passage in each piece of content. For instance, an original edition of a passage in a piece of content may be assigned a passage edition ID when the content is segmented into passages. Additionally, or alternatively, an adapted edition of a passage may be assigned a passage edition ID when the adapted edition is made from another edition of the passage (which maybe the original edition or another adapted edition).

Thus, the same passage in a piece of content may have multiple entries in the passage edition table, each entry corresponding to a different edition of the passage.

The entry 605 may store any suitable information associated with a passage edition identified by the passage edition ID. For instance, in the example of FIG. 6, the entry 605 stores a title, a passage number, passage edition text, an audio ID, a language, a dialect, a reading level, a culture, etc. Additionally, or alternatively, the entry 605 may store a volume, a version identifier, an author, a copyright date, etc.

Additionally, or alternatively, the entry 605 may store information indicating an adaptation lineage for the passage edition identified by the passage edition ID. For instance, the passage edition may be a Mexican Spanish edition of the passage generated from a Silver edition of the passage, which in turn may have been generated from an original (English) edition of the passage (e.g., by reducing complexity by 4-6 grade levels). Accordingly, the entry 605 may store a list of passage edition ID(s) corresponding, respectively, to one or more passage editions from which the current passage edition descended. The passage edition ID(s) may be ordered in any suitable manner, e.g., from the closest ancestor to the most distant ancestor, or vice versa.

In some embodiments, the content delivery platform 100 may look up the entry 605 from the passage edition table in response to a user request, and may cause the illustrative content delivery interface 500 in the example of FIG. 5 to display the passage edition text stored in the entry 605.

As an example, the user may use the illustrative user device 105 in the example of FIG. 1 to scan the illustrative QR code 115, enter a passage number via the illustrative input field 345 in the example of FIG. 3, and use the illustrative menus 515A and 515B in the example of FIG. 5 to select a reading level and a language, respectively. The content delivery platform 100 may obtain a title based on information encoded in the QR code 115 (e.g., the title itself, or some other information), and may perform a lookup using the title, the passage number, the reading level, and the language.

As another example, the user may use the user device 105 to scan the illustrative QR code 410 in the example of FIG. 4, and use the menus 515A and 515B in the example of FIG. 5 to select a reading level and a language, respectively. The content delivery platform 100 may perform a lookup using a title and a passage number obtained based on information encoded in the QR code 410 (e.g., the title and the passage number themselves, or some other information), along with the reading level and the language.

As yet another example, the passage edition ID may be encoded in the QR code 410. The content delivery platform 100 may obtain the passage edition ID from the QR code 410, and may perform a lookup using the passage edition ID.

In some embodiments, the entry 605 may store audio data, or a reference thereto, for the passage edition identified by the passage edition ID. In the example of FIG. 6, the audio ID stored in the entry 605 may be used to look up an audio table and retrieve an entry 610. The entry 610 may store audio data obtained from the passage edition text stored in the entry 605 (e.g., by calling a TTS service with the passage edition text, or by recording a human reading the passage edition text).

The entry 610 may store any suitable data in addition to, or instead of, the audio data. For instance, the entry 610 may store timestamp metadata, or a reference thereto, for the audio data. In the example of FIG. 6, the entry 610 stores a timestamp metadata ID, which may be used to look up a timestamp metadata table and retrieve an entry 615. The entry 615 may store any suitable timestamp metadata, such as timestamp metadata at a morpheme level, at a word level, at a phrase level, at a clause level, at a sentence level, at a paragraph level, etc.

In the example of FIG. 6, the entry 610 stores word-level timestamps and sentence-level timestamps. This may advantageously allow the user to choose between word-level synchronization and sentence-level synchronization, as discussed in connection with the example of FIG. 5. However, it should be appreciated that aspects of the present disclosure are not limited to having timestamps at different levels of granularity, or any timestamp at all.

In some embodiments, the content delivery platform 100 may process an output of a TTS service and populate a data structure for each timestamp. Any suitable data schema may be used, such as the following for a given linguistic unit (e.g., morpheme, word, phrase, clause, sentence, paragraph, etc.).
unitID—identifier for the linguistic unit
positionIndex—character position of the linguist unit within the passage edition
startTime—timestamp (e.g., in msec) for the start of the linguistic unit within the audio
endTime—timestamp (e.g., in msec) for the start of the linguistic unit within the audio

It should be appreciated that the above data schema is provided solely for purposes of illustration. In various embodiments, more, fewer, and/or different fields may be used. For instance, the unitID field may be omitted, and the position index may be used to identify the linguistic unit, or vice versa.

Additionally, or alternatively, a timestamp data structure may include a reference to the entry 615, a reference to the entry 610, and/or a reference to the entry 605. Additionally, or alternatively, the entry 615 may include a reference to the entry 610 and/or a reference to the entry 605. Additionally, or alternatively, the entry 610 may include a reference to the entry 605.

Such reference(s) may allow efficient navigation across different data tables. For instance, the user may wish to switch from the current passage edition to a different edition of the same passage (e.g., in a selected language and/or at a selected reading level). In response, one or more of the above-described references may be used to navigate to the entry 605. The title and/or the passage number stored in the entry 605 may be used to look up a desired passage edition. Additionally, or alternatively, the desired passage edition may be identified from one or more ancestor passage editions in the adaptation lineage of the current passage edition.

The inventors have recognized and appreciated that, if timestamps are maintained at multiple levels of granularity (e.g., word and sentence), it may be desirable to organize timestamp data structures in a hierarchical manner. For instance, a timestamp data structure for a smaller linguistic unit (e.g., a word) may include a reference to a timestamp data structure for a larger linguistic unit (e.g., a sentence) to which the smaller linguistic unit belongs.
parentID—identifier for parent linguistic unit

Additionally, or alternatively, a timestamp data structure for a larger linguistic unit (e.g., a sentence) may include reference(s) to one or more timestamp data structures for smaller linguistic unit(s) (e.g., word(s)) belonging to the larger linguistic unit.
childIDs—list of identifier(s) for child linguistic unit(s) (e.g., sorted in an order in which the child linguistic unit(s) appear in the parent linguistic unit)

The inventors have recognized and appreciated that, in some instances, a TTS service may not output timestamps at a desired level of granularity. For instance, some TTS services may output sentence-level timestamps, but not word-level timestamps, while some TTS services may output no timestamp metadata at all.

Accordingly, in some embodiments, the content delivery platform 100 may be configured to populate a timestamp data structure by estimating a start time and/or an end time of a given linguistic unit. For instance, if sentence-level timestamps are available, but not word-level timestamps, the content delivery platform 100 may estimate boundaries of a given word in the audio based on a length of a sentence to which the word belongs (e.g., in terms of number of words and/or number of characters), a length of the word (e.g., in terms of number of characters), a position of the word within the sentence, and/or a playback duration of the sentence (e.g., as obtained based on sentence-level timestamps output by a TTS service).

Additionally, or alternatively, if no timestamp metadata is available, the content delivery platform 100 may estimate boundaries of a given sentence in the audio based on a length of the passage edition text (e.g., in terms of number of words and/or number of characters), a length of the sentence (e.g., in terms of number of words and/or number of characters), a position of the sentence within the passage edition text, and/or a playback duration of the entire audio. Thus, the content delivery interface 500 may be able to default to sentence-level synchronization between textual display and audio playback.

The inventors have recognized and appreciated that some languages may have complex morphology and/or syntax. As a result, the length of a word may not correlate well with audio duration of the word, and likewise for a sentence. For instance, Spanish and Arabic often have longer inflected forms, while English relies more on stress patterns.

Accordingly, in some embodiments, a prosodic contour of the audio may be used to finetune word- and/or sentence-level timestamp metadata. For instance, one or more occurrences of pause and/or emphasis may be used to adjust word- and/or sentence-level timestamps.

In some instances, the passage edition text may be provided to the content delivery platform 100 without metadata regarding sentence boundaries. Accordingly, in some embodiments, the content delivery platform 100 may apply one or more natural language processing (NLP) techniques to segment the passage edition text into sentences, before attempting to estimate sentence boundaries in the audio.

A length of a linguistic unit (e.g., morpheme, word, phrase, clause, sentence, paragraph, passage, etc.) may be measured in any suitable manner, for example, based on a number of characters or phonemes in the linguistic unit. Likewise, a position of a smaller linguistic unit (e.g., word or sentence) within a larger linguistic unit (e.g., sentence or paragraph, respectively) may be given in any suitable manner, for example, as a character or phoneme position of the smaller linguistic unit within the larger linguistic unit.

The inventors have recognized and appreciated that, even if a TTS service does output timestamps at a desired level of granularity, such timestamps may be inaccurate. Accordingly, in some embodiments, techniques are provided for detecting potential errors in timestamps output by a TTS service.

For instance, given an input text, a TTS service may output audio data along with a transcript that is annotated with word-level timestamps. The transcript may not match the input text precisely. The content delivery platform 100 may traverse the input text, and attempt to match each word in the input text with a word in the output transcript. This may be done after removing punctuations from both the input text and the output transcript.

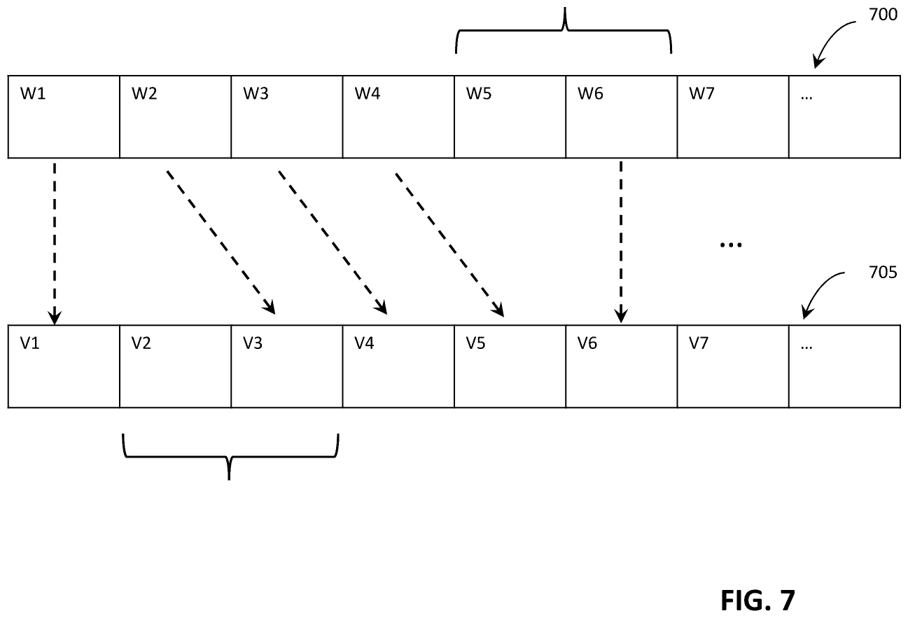

FIG. 7 shows an illustrative input text 700 and an illustrative output transcript 705, in accordance with some embodiments. In this example, the input text 700 includes words W1, W2, W3, etc., and the output transcript 705 includes words V1, V2, V3, etc.

In some embodiments, the illustrative content delivery platform 100 in the example of FIG. 1 may attempt to match words in the input text with words in the output transcript. For instance, the content delivery platform 100 may start with W1, and check if V1 matches W1. If so, the content delivery platform 100 may move on to W2, and check if V2 matches W2.

It should be appreciated that such matching may be imprecise. As an example, V1 may be considered a match for W1 if V1 is a plural form of W1, or vice versa. As another example, V1 may be considered a match for W1 if V1 is a conjugated form of W1, or vice versa. Any suitable set of one or more rules may be provided to determine whether a word matches another.

In some embodiments, if a mismatch is encountered, the content delivery platform 100 may look ahead to attempt to find a match. As an example, if V2 does not match W2, the content delivery platform 100 may check if V3, or the combination of V2 and V3, matches W2. (For instance, “website” may be one word in the input text, but broken up into two words, “web site” in the output transcript.) If V3, or the combination of V2 and V3, matches W2, a beginning timestamp for V2 and an ending timestamp for V3 may be used, respectively, as a beginning timestamp and an ending timestamp for W2.

As another example, if V6 does not match W5, the content delivery platform 100 may check if V6 matches the combination of W5 and W6. If so, W5 and W6 may be treated as a unit for synchronizing textual display with audio playback. For instance, W5 and W6 may be highlighted together, and a beginning timestamp and an ending timestamp for V6 may be used, respectively, as a beginning timestamp and an ending timestamp for the unit comprising W5 and W6.

It should be appreciated that aspects of the present disclosure are not limited to detecting errors in timestamps in any particular manner, or at all. In some embodiments, word- and/or sentence-level timestamps may be generated using the input text and the audio data, without reference to any transcript output by the TTS service. This may be done in any suitable manner, for example, using any one or more of the techniques described herein and/or other techniques (e.g., a forced alignment technique).

The inventors have recognized and appreciated that different user devices and/or web browsers may have different APIs for audio playback. As a result, it may be challenging for the content delivery interface 500 to track progress of audio playback in real time.

Accordingly, in some embodiments, an event generator may be provided on the illustrative user device 105 in the example of FIG. 1. The event generator may poll an audio player for a current playback position. This may be done in any suitable manner, for example, periodically at N-msec intervals, where N is selected to achieve a desired tradeoff between computational costs and smoothness of synchronization (e.g., N=10, 25, 50, . . . ). For instance, more frequent polling (i.e., a smaller N) may result in smoother synchronization, but may be more costly computationally. By contrast, less frequent polling (e.g., a larger N) may result in choppier synchronization, but may be less costly computationally.

It should be appreciated that aspects of the present disclosure are not limited to polling an audio player at regular intervals. In some embodiments, the event generator may poll an audio player at irregular intervals (e.g., upon detecting that audio playback and textual display have become misaligned).

The inventors have recognized and appreciated that, while the event generator may be configured to poll the audio player at regular intervals (e.g., every N msec), sometimes polling events may not take place precisely as scheduled. For instance, a web browser may deprioritize background tabs, and/or a processor may become overloaded.

Accordingly, in some embodiments, the event generator may be configured to track actual polling intervals. For instance, the event generator may calculate an average polling interval based on actual polling intervals. If the average polling interval is more than a threshold amount (e.g., 5 msec) longer than a target polling interval (e.g., N msec), a resynchronization between textual display and audio playback, and/or an adjustment of the textual display, may be triggered.

In some embodiments, the content delivery platform 100 may retrieve timestamp metadata dynamically. For instance, in response to the user clicking the illustrative Listen button 520 in the example of FIG. 5, the content delivery platform 100 may access timestamp metadata associated with a passage edition that is currently displayed in the content delivery interface 500.

Referring again to the example of FIG. 6, the content delivery platform 100 may use an audio ID stored in the entry 605 to navigate to the entry 610, and may use a timestamp metadata ID stored in the entry 110 to navigate to the entry 615. The content delivery platform 100 may then access word-level timestamps and/or sentence-level timestamps from the entry 615, and may send such timestamp metadata to the user device 105.

It should be appreciated that aspects of the present disclosure are not limited to retrieving audio data and/or timestamp metadata dynamically. In some embodiments, audio data and/or timestamp metadata for a frequently requested passage edition may be cached by the content delivery platform 100, which may improve performance.

Additionally, or alternatively, the content delivery platform 100 may transmit audio data and/or timestamp metadata for a passage to the user device 105 while the user is still listening to a previous passage. This may provide a smoother transition between passages (e.g., when autoplay is enabled).

In some embodiments, the event generator may use timestamp metadata received from the content delivery platform 100 to determine when to generate an event indicating a next linguistic unit has become active and therefore should be visually differentiated (e.g., via highlighting).

For instance, when the event generator receives a poll response from the audio player, the event generator may record a playback position pᵢ and a time tᵢ at which the playback position pᵢ is received. Until the audio player is polled again, the event generator may use pᵢ, tᵢ, and a current time t to estimate a current playback position. When an estimated current playback position reaches a start time for a next linguistic unit at a selected granularity, the event generator may register an event to trigger an update of textual display in the content delivery interface 500.

In some instances, the user may slow down or speed up audio playback (e.g., to 0.75× or 1.5×). Accordingly, the event generator may use an API of the audio player to obtain a current playback rate. This playback rate may be used to estimate the current playback position, for example, as described above.

In some embodiments, the content delivery interface 500 may listen for events from the event generator, and may update the textual display accordingly. For instance, an event from the event generator may indicate a synchronization granularity to which the event pertains (e.g., word level or sentence level), and the content delivery interface 500 may visually differentiate a next linguistic unit at that granularity.

It should be appreciated that aspects of the present disclosure are not limited to estimating a current playback position in any particular manner, or at all. In some embodiments, the event generator may register an event when the playback position pᵢ received from the audio player indicates a start time for a next linguistic unit at a selected granularity has passed. This may result in a slight delay in updating the textual display, but may avoid updating the textual display prematurely.

Additionally, or alternatively, the event generator may use multiple received playback positions ¿pᵢ, tᵢ>, <pᵢ₋₁, tᵢ₋₁>, . . . to estimate a playback position at a current time t. For instance, the event generators may use two or more such data points to estimate an audio playback speed, which may in turn be used to estimate the current playback position (e.g., based on a most recent playback position received from the audio player).

Additionally, or alternatively, the content delivery interface 500 may notify the event generator when the user uses the illustrative playback control 525 in the example of FIG. 5 to pause, rewind, fast forward, change playback speed, etc. In response, the event generator may poll the audio player anew, and recalculate an estimate of the current playback position.

Additionally, or alternatively, the user may select a word displayed in the content delivery interface 500 (e.g., by clicking on the word). In response, the content delivery interface 500 may identify, from the word-level timestamps, a start time for the selected word, and may begin audio playback at that start time.

Referring again to the example of FIG. 6, the passage edition text stored in the entry 605, the audio data stored in the entry 610, and/or the timestamps stored in the entry 615 may be updated. For instance, the passage edition may be an adapted edition, and an error in the adaptation may be discovered. Accordingly, the passage edition text stored in the entry 605 may be updated to correct the error, which may trigger regeneration of audio data. The existing audio data stored in the entry 610 may be replaced by newly generated audio data, which may in turn trigger regeneration of timestamp metadata. The existing timestamp metadata stored in the entry 615 may then be replaced by newly generated timestamp metadata.

However, it should be appreciated that aspects of the present disclosure are not limited to updating an existing entry when an adaptation is regenerated. In some embodiments, a new entry may be created, which may have a different passage edition ID. The new entry may store some of the same information from the existing entry, such as title, volume, passage number, language, dialect, reading level, culture, author, etc. But other information may be different, such as passage edition text, audio ID, version, copyright date, etc. The new audio ID may reference a new entry in the audio table, which may store new audio data generated from the new text. The new entry in the audio table may in turn reference a new entry in the timestamp metadata table (with a timestamp metadata ID), which may store new timestamp metadata associated with the new audio data.

The inventors have recognized and appreciated that, if new entries are created whenever adaptations are regenerated, a search by the content delivery platform 100 (e.g., based on title, passage number, language, dialect, reading level, culture, etc.) may return multiple matches. Accordingly, in some embodiments, an entry may be marked as a preferred version. Such an entry may be selected in any suitable manner, for example, according to one or more rules (e.g., selecting a latest version by default) and/or by an administrator.

Additionally, or alternatively, an entry may be marked as being private. For instance, an entry may store metadata associating the entry with a user (e.g., a teacher, a student, etc.), an organization (e.g., a school, a corporation, etc.), a particular copy of a piece of content, a batch of copies of one or more pieces of content, etc. Such an entry may be selected in response to a request associated with the corresponding user, organization, copy, batch, etc.

As discussed above, a copy of a piece of content may be associated with a code. As an example, a hard copy may have a QR code printed thereon or affixed thereto. As another example, an electronic text copy may include a QR code on a cover page or any other suitable page. As yet another example, an audio copy may include an alphanumeric code read aloud in the audio. As yet another example, an electronic copy (e.g., text, audio, video, etc.) may include a QR code as metadata, and a software application (e.g., a local or web application) may be configured to read and display the QR code.

A code associated with a copy of a piece of content may be used directly or indirectly to obtain information relating to the content, such as a title, a volume, an edition, a version, a language, a dialect, a reading level, a culture, an author, a copyright date, etc. For instance, the information may be embedded into the code, or may be retrieved using the code (e.g., by looking up a database).

The inventors have recognized and appreciated that it may be desirable to provide information relating to one or more users of a piece of content, in addition to, or instead of, information relating to the content itself.

For instance, the inventors have recognized and appreciated that different user populations may have different needs. As an example, second language learners may benefit from access to translated editions of materials, whereas students with certain learning disabilities (e.g., dyslexia) may benefit from reduced complexity and/or synchronization between textual display and audio playback.

Accordingly, in some embodiments, a code associated with a copy of a piece of content may be used to obtain a batch identifier. For example, a school may place an order for multiple hard copies of a book to be provided to second language learners. A QR code printed on each hard copy produced and/or shipped under the particular order may be used to obtain a batch identifier associated with the order. This may be done directly (e.g., by recovering the batch identifier itself from the QR code) or indirectly (e.g., by using information recovered from the QR code to retrieve the batch identifier).

Upon receiving a request triggered by such a QR code (e.g., as described in connection with the examples of FIGS. 3-4), the content delivery platform 100 in the example of FIG. 1 may obtain a corresponding batch identifier, and may use the batch identifier to determine one or more features to be enabled or disabled. For instance, the content delivery platform 100 may cause the illustrative content delivery interface 300 in the example of FIG. 3 to enable the illustrative menu 315B for selecting a language, but disable the illustrative menu 315A for selecting a reading level.

In some embodiments, a set of feature(s) to be enabled and/or a set of feature(s) to be disabled may be selected when an order is placed, and may be stored in association with a batch identifier for the order. However, it should be appreciated that aspects of the present disclosure are not limited to enabling or disabling any particular feature or combination of features, or any feature at all.

For instance, when placing an order for students with certain learning disabilities (e.g., dyslexia), a teacher may indicate that the menu 315B for selecting a language should be disabled, but the menu 315A for selecting a reading level should be enabled. Additionally, or alternatively, the teacher may indicate that the illustrative Listen button 520 in the example of FIG. 5 should be enabled, along with synchronization between textual display and audio playback. Additionally, or alternatively, the teacher may indicate that a decode mode should be activated.

As another example, when placing an order for students who are visually impaired, a teacher may indicate one or more formatting settings, such as a selected layout, a selected typeface, a selected font, a selected size, a selected color filter, etc.

It should be appreciated that aspects of the present disclosure are not limited to using a batch identifier in any particular manner, or at all. Moreover, a batch identifier may be associated with a batch consisting of a single hard copy, which may be provided to a single student, or shared among multiple students.

The inventors have further recognized and appreciated that it may be desirable to provide content personalization in a manner that preserves privacy. For example, it may be desirable to allow a student to create a personalized edition of a book (e.g., in a selected language and/or at a selected reading level) without collecting personal information from the student. This may facilitate compliance with privacy laws and regulations, such as the Children's Online Privacy Protection Act (COPPA).

Accordingly, in some embodiments, a code associated with a copy of a piece of content may be used to obtain an identifier that is unique to that particular copy (hereafter, a per-copy identifier). The per-copy identifier may be used to track the user's activities (e.g., notes taken by the user, creation of a personalized edition, etc.) without collecting any personal information.

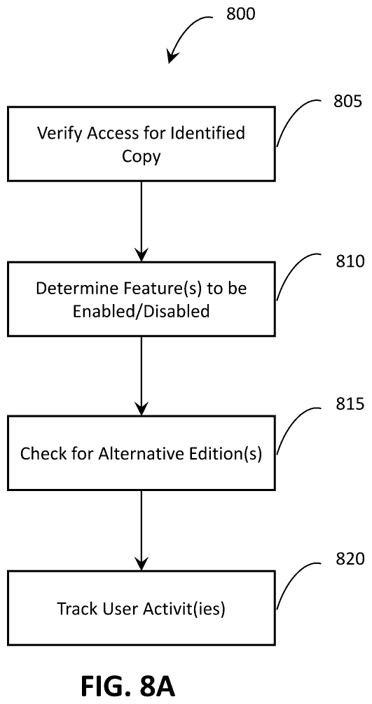

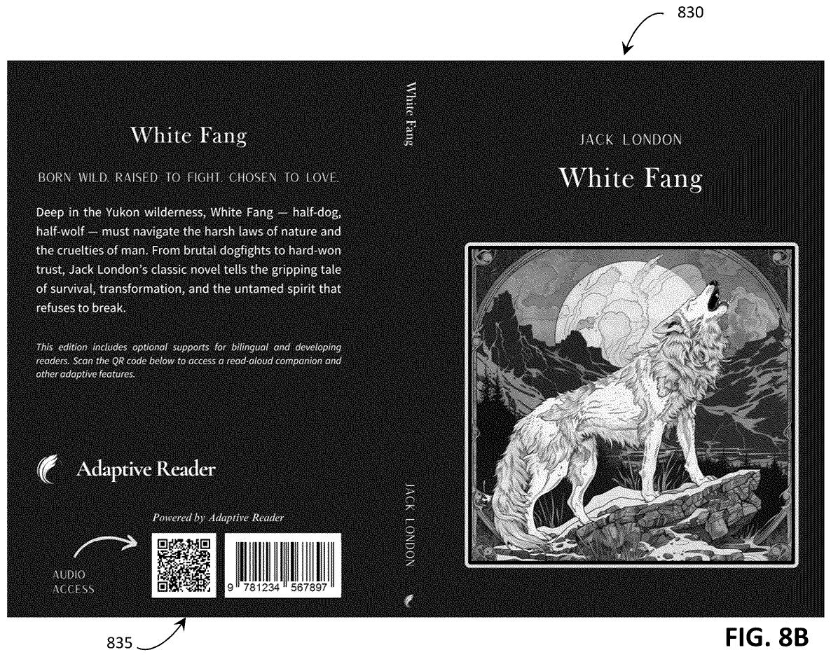

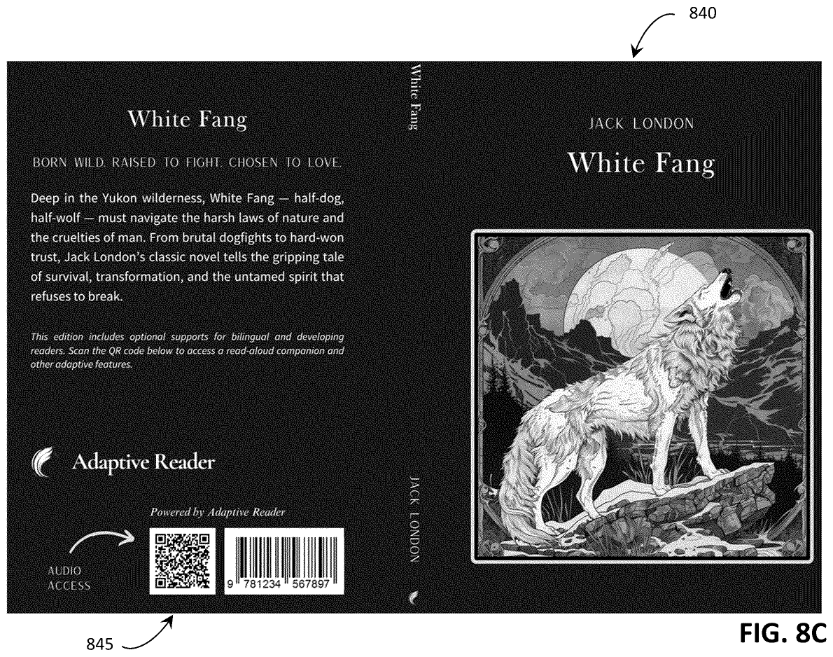

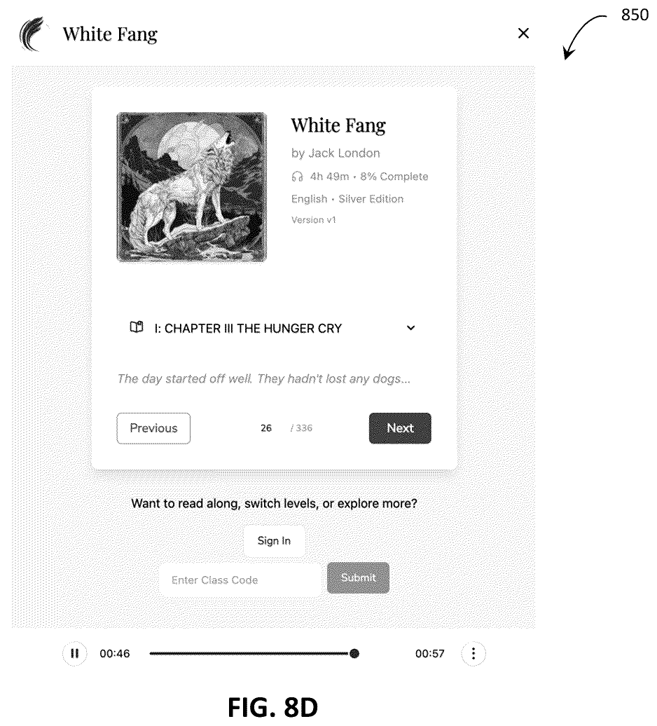

FIG. 8A shows an illustrative process 800 for providing access to content, in accordance with some embodiments. For instance, the process 800 may be performed by the illustrative content delivery platform 100 in the example of FIG. 1 in response to a user using the illustrative user device 105 to scan a QR code printed on a hard copy of a book.

However, it should be appreciated that aspects of the present disclosure are not limited to scanning a QR code printed on a hard copy. The process 800 may be performed in response to any suitable code associated with any suitable copy being provided to the content delivery platform 100 in any suitable manner.

FIGS. 8B and 8C show, respectively, illustrative covers 830 and 840, in accordance with some embodiments. The covers 830 and 840 may be identical, except a QR code 835 on the cover 830 may be different from a QR code 845 on the cover 840. The QR codes 835 and 845 may encode, respectively, the following links.
https://app.adaptivereader.com/qr/aecb2775-c53f-4e00-b170-fae99a551f0a
https://app.adaptivereader.com/qr/185ee346-9769-41cf-a953-922599166bd5

Referring again to the example of FIG. 8A, the user device 105 may, in response to the user scanning a QR code (e.g., the illustrative QR code 835 in the example of FIG. 8B, or the illustrative QR code 845 in the example of FIG. 8C), transmit a request to the content delivery platform 100. The request may include any suitable information, such as a per-copy identifier recovered from the QR code, or information recovered from the QR code that may be used by the content delivery platform 100 to retrieve the per-copy identifier (e.g., the link encoded by the QR code 835 or the QR code 845).

At act 805, the content delivery platform 100 may use the per-copy identifier to verify access. For instance, the content delivery platform 100 may maintain an access control data structure, which may store per-copy identifiers and associated access rules. The content delivery platform 100 may use the per-copy identifier to look up one or more access rules from the access control data structure, and may apply the one or more access rules to determine whether/what access should be granted.

Any suitable access rule may be applied. As an example, an access rule may be based on a network address, such as an Internet Protocol (IP) address, associated with the request. For instance, the hard copy may be acquired by a school for use by its students, and the per-copy identifier may be associated with an IP address of the school. Thus, access may be granted if the request is sent by the user device 105 via the school's computer network.

As another example, an access rule may be based on a device identifier associated with the request. For instance, the user may have previously registered the hard copy with the content delivery platform 100 by using the user device 105 to scan the QR code. The content delivery platform 100 may have associated the per-copy identifier with a device identifier (e.g., a media access control (MAC) address) of the user device 105.

As yet another example, an access rule may be based on a password and/or a passkey. For instance, the user may have previously registered the hard copy with the content delivery platform 100, and may have provided a password during that process. The content delivery platform 100 may have associated the per-copy identifier with the password or a suitable hash thereof (e.g., a salted hash).

Additionally, or alternatively, the user may have previously used a passkey to register the hard copy with the content delivery platform 100. The passkey may include a private key of a public-private key pair generated according to a suitable asymmetric cryptosystem, and the content delivery platform 100 may have associated the per-copy identifier with a public key of the key pair.

FIG. 8D shows an illustrative content delivery interface 850, in accordance with some embodiments. The content delivery interface 500 may be presented by the illustrative content delivery platform 100 in the example of FIG. 1 in response to the user scanning the illustrative QR code 835 in the example of FIG. 8B or the illustrative QR code 845 in the example of FIG. 8C. This may be done in any suitable manner, for example, by redirecting a web browser on the illustrative user device 105 to the following web page.
https://app.adaptivereader.com/listen/white-fang/v1/en:silver/1

In this example, the content delivery platform 100 may use the link encoded by the QR code 835 or the QR code 845 to determine an access rule. The access rule may be based on an access code. For instance, the QR codes 835 and 845 may be printed, respectively, on hard copies ordered by a teacher for students in a class. The content delivery platform 100 may associate the links encoded by the QR codes 835 and 845 with a class code, and may provide the class code to the teacher. The teacher may, in turn, provide the class code to the students.

Referring again to the example of FIG. 8A, the content delivery platform 100 may, at act 810, determine one or more features to be enabled and/or one or more features to be disabled.

In some embodiments, a set of feature(s) to be enabled and/or a set of feature(s) to be disabled may be selected during a registration process, and may be stored in association with a per-copy identifier. Examples of features include, but are not limited to, translation, reading level adaptation, audio playback, display adaptation, etc. Examples of display adaptation include, but are not limited to, a selected layout, a selected typeface, a selected font, a selected size, a selected color filter, a decode mode, etc.

However, it should be appreciated that aspects of the present disclosure are not limited to enabling or disabling any particular feature or combination of features, or any feature at all. Moreover, aspects of the present disclosure are not limited to registering a copy in any particular manner, or at all.

For instance, a teacher may distribute a plurality of hard copies of a book to a plurality of students, respectively. Prior to giving a hard copy to a student with a learning disability, the teacher may register that hard copy with the content delivery platform 100. For example, the teacher may scan a QR code printed on the hard copy, and may use an administrator interface of the content delivery platform 100 to select one or more features to be enabled and/or one or more features to be disabled for that particular hard copy. The content delivery platform 100 may store the teacher's selection in association with a per-copy identifier obtained using the QR code.

The one or more features to be enabled and/or the one or more features to be disabled may be selected in any suitable manner. For instance, the teacher may upload, to the content delivery platform 100, an Individualized Education Program (IEP) for the student for whom the hard copy is intended. The content delivery platform 100 may be configured to process the IEP and select the one or more features to be enabled/disabled accordingly.

In some embodiments, the IEP for the student may describe one or more accommodations to be received by the student, but may not include any personally identifiable information (PII) of the student.

Referring again to the example of FIG. 8A, the content delivery platform 100 may, at act 815, check whether one or more alternative editions exist. For example, the content delivery platform 100 may determine whether the copy identified by the per-copy identifier is of an edition that is out of date or otherwise less desirable than another available edition.

This may be done in any suitable manner. For instance, the content delivery platform 100 may perform a search (e.g., as described in connection with the example of FIG. 6) based on information obtained using the QR code (e.g., title, passage number, language, dialect, reading level, culture, etc.). If multiple matches are returned, the content delivery platform 100 may determine whether one or more matches are more desirable (e.g., more recent, and/or better scored by one or more human reviewers) than the edition of the copy identified by the per-copy identifier.

In some embodiments, the content delivery platform 100 may prompt the user to indicate whether the user wishes to access a more desirable edition (e.g., a most recent edition, or an edition with a highest score). This may be done in any suitable manner, for example, via the illustrative content delivery interface 300 in the example of FIG. 3 or the illustrative content delivery interface 500 in the example of FIG. 5.

If the user answers affirmatively, the content delivery platform 100 may cause the content delivery interface 300 or the content delivery interface 500 to display the recommended edition, as opposed to the edition of the copy identified by the per-copy identifier.

In some instances, the copy identified by the per-copy identifier may be a hard copy, and the user may wish to read the hard copy while listening to corresponding audio. Accordingly, the user may reject the recommended edition, and the content delivery platform 100 may cause the content delivery interface 500 to display the edition of the hard copy and/or play the corresponding audio.

The inventors have recognized and appreciated various advantages of continually updated content. For instance, if an area of science or technology is particularly active, new discoveries, innovations, and/or other updates may be made frequently (e.g., Pluto being reclassified from a full planet to a dwarf planet). Thus, textbooks for that area of science or technology may become out of date quickly. Therefore, it may be advantageous to ensure that the user has access to the most recent edition.

However, it should be appreciated that aspects of the present disclosure are not limited to updating content in any particular manner, or at all.

Referring again to the example of FIG. 8A, the content delivery platform 100 may, at act 820, track one or more user activities. As an example, the content delivery platform 100 may track, for each passage, how much time the user spends reading the passage, whether the user listened to audio of the passage, how often the user rewinds, at which sentence(s) the user rewinds, etc. The content delivery platform 100 may analyze such activities to produce a score indicating how challenging the user finds the particular passage, and may store the score in association with the per-copy identifier and/or a corresponding passage number.

As another example, the content delivery platform 100 may allow the user to store a personalized edition of the content. For instance, the user may find a particular passage in a translated edition challenging to understand, and may request that the passage be retranslated. The content delivery platform 100 may create a new entry in a passage edition table (e.g., as described in connection with the example of FIG. 6), and may associate the new entry with the per-copy identifier.

In this manner, the content delivery platform 100 may select the new entry in response to a request associated with the per-copy identifier, while the existing entry may be selected in response to other requests. However, it should be appreciated that aspects of the present disclosure are not limited to creating or maintaining personalized content.

In some embodiments, feedback from multiple users may be collected. Such feedback may be used to improve adaptations.

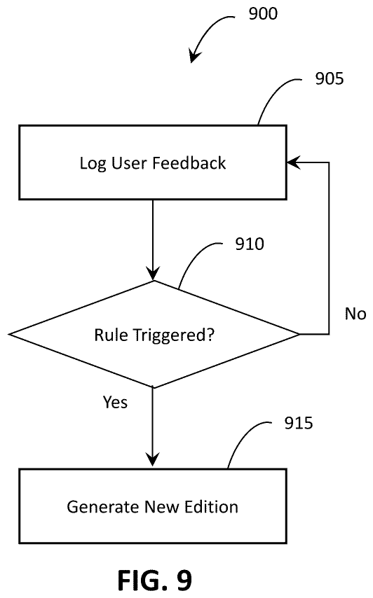

FIG. 9 shows an illustrative process 900 for generating a new edition of a piece of content, in accordance with some embodiments. For instance, the process 900 may be performed by the illustrative content delivery platform 100 in the example of FIG. 1 to continually regenerate an adaptation of a passage.

At act 905, the content delivery platform 100 may log feedback received from one or more users regarding an adapted edition of the passage. Any form of feedback may be logged. As an example, a user may identify an error in a translated edition. As another example, a user may have selected a desired reading level, but an adapted edition provided by the content delivery platform 100 may appear to be too simple or too complex for the selected reading level.

The content delivery platform 100 may log such feedback in any suitable manner. For instance, the content delivery platform 100 may store an instance of feedback in association with any suitable metadata, such as (i) a title, a passage number, and/or a passage edition identifier to which the feedback relates, (ii) a per-copy identifier associated with the feedback, (iii) a type of user providing the feedback (e.g., student, teacher, editor, subject matter expert, etc.), (iv) a data and/or time at which the feedback is received, (v) a language in which the feedback is received, etc.

At act 910, the content delivery platform 100 may apply one or more rules to determine whether to generate a new edition of the passage.

Any suitable rule may be used. As an example, a rule may be based on a number of instance(s) of feedback on a particular edition, and/or significance of such feedback. For instance, feedback from an editor may be given more weight compared to feedback from a user. Additionally, or alternatively, users may be scored based on quality of past feedback (e.g., as determined by relevant experts). Accordingly, feedback from a user with a higher score may be given more weight compared to feedback from a user with a lower score.

As another example, a rule may be based on availability of one or more improved AI models (e.g., large language models (LLMs)) that may be used to generate a new edition.

As yet another example, a rule may be based on availability of one or more new editorial guidelines (e.g., inclusive language, regional conventions, etc.). Such an editorial guideline may be used to fine tune one or more prompts for generating a new edition.

If no rule is triggered at act 910, the content delivery platform 100 may continue to log user feedback at act 905. Otherwise, the content delivery platform 100 may proceed to act 915 to generate a new edition for the passage based on one or more rules triggered at act 910.

It should be appreciated that aspects of the present disclosure are not limited to using a rule to determine whether to generate a new edition of a passage. In some embodiments, an editor may instruct the content delivery platform 100 to generate a new edition, for example, to refine a style and/or a tone of an adaptation.

In some embodiments, the content delivery platform 100 may perform quality control on passage edition text generated at act 915. For instance, the content delivery platform 100 may compute one or more values according, respectively, to one or more quality metrics. For each quality metric, the content delivery platform 100 may determine whether the computed value falls within a set of acceptable values (e.g., a range of values corresponding to a desired reading level). If the computed value falls outside the set of acceptable values, the content delivery platform 100 may flag the passage edition text for editorial review and/or regeneration.

Examples of quality metrics include, but are not limited to:
Readability scores, such as FKGL, SMOG, FOG, etc.
Reading-level fit metrics, such as average sentence length, clause depth, language-appropriate readability indices, etc.
Lexical profile metrics, such as high-frequency coverage, rare-word rate, glossary adherence, etc.
Terminology and/or named-entity consistency across editions.
Faithfulness to source edition (e.g., using alignment and/or semantic-similarity measures to detect omissions and/or additions).
Multilingual and/or locale checks, such as agreement, orthography, punctuation, diacritics, rendering (e.g., left to right, right to left, top to bottom, etc.)
Audio synchronization metrics, such as proportion of words aligned via forced alignment, mean absolute timestamp error, pause-at-punctuation consistency, audio-to-text duration delta, etc.
Accessibility and/or formatting checks, such as presence of alternative text for images, passage-identifier continuity, QR code presence and/or resolvability, print-layout constraints, etc.

In some embodiments, if one or more quality issues are identified, the content delivery platform 100 may regenerate the passage edition text. For instance, the content delivery platform 100 may modify one or more prompts to address the one or more quality issues, and may regenerate the passage edition text using the one or more modified prompts.

If no quality issue is identified, the content delivery platform 100 may create a new entry in a passage edition table (e.g., as described in connection with the example of FIG. 6) with the newly generated passage edition text.

While certain details of implementation are described herein, it should be appreciated that such details are provided solely for purposes of illustration. Moreover, it should be appreciated that a content delivery platform (e.g., the illustrative content delivery platform 100 in the example of FIG. 1) and a content delivery interface (e.g., the illustrative content delivery interface 300 in the example of FIG. 3 or the illustrative content delivery interface 500 in the example of FIG. 5) may be provided by different entities.

In some embodiments, the content delivery platform 100 may expose an application programming interface (API). The API may have one or more endpoints for: (i) requesting translated and/or adapted editions of a passage, corresponding audio data, and/or corresponding timestamp metadata; (ii) exchanging per-copy identifiers and/or access tokens for feature gating; and/or (iii) submitting feedback and/or usage data for text and/or audio regeneration and/or analytics.

Additionally, or alternatively, a software development kit (SDK) may be provided to allow third parties to build systems (e.g., publisher platforms, learning-management systems, accessibility tools, etc.) that interact the content delivery platform 100. For instance, the SDK may be used to embed, into a third-party system, one or more functionalities such as synchronized textual display (e.g., as described in connection with the example of FIG. 3), synchronized textual display and audio playback (e.g., as described in connection with the example of FIG. 5), and/or audio playback only.

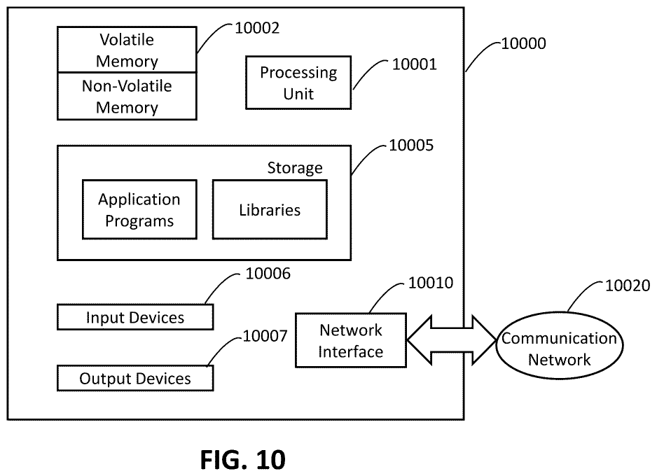

FIG. 10 shows, schematically, an illustrative computer 10000 on which any aspect of the present disclosure may be implemented. The computer 10000 may include at least one computer hardware processor 10001 and at least one memory 10002. The at least one memory 10002 may include a volatile memory and/or a non-volatile memory, and may store one or more instructions to program the at least one computer hardware processor 10001 to perform any of the functions described herein. Such a memory may be an article of manufacture comprising at least one non-transitory computer-readable medium.

In some embodiments, the computer 10000 may also include other types of non-transitory computer-readable media, such as a storage 10005, in addition to the at least one memory 10002. The storage 10005 may include one or more disk drives, and may store one or more application programs and/or one or more resources used by the one or more application programs (e.g., one or more software libraries). Instructions of the one or more application programs and/or the one or more resources may be loaded into the at least one memory 10002 for execution by the at least one computer hardware processor 10001, for example, to perform any of the illustrative functionalities described herein.

The computer 10000 may have one or more input devices and/or output devices, such as input devices 10006 and output 10007 illustrated in FIG. 10. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 10007 may include a microphone for capturing audio signals, and the output devices 10006 may include a display screen for visually rendering, and/or a speaker for audibly rendering, recognized text.

In the example of FIG. 10, the computer 10000 may also include one or more network interfaces (e.g., a network interface 10010) to enable communication via various networks (e.g., a communication network 10020). Examples of networks include local area networks (e.g., an enterprise network), wide area networks (e.g., the Internet), etc. Such networks may be based on any suitable technology, and may operate according to any suitable protocol. For instance, such networks may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in field programmable gate arrays or other semiconductor devices, or other tangible computer-readable media) encoded with one or more programs that, when executed on one or more processors, perform methods that implement the various embodiments of the present disclosure described herein. The computer-readable medium or media may be portable, such that the program or programs stored thereon may be loaded onto one or more different computers or other processors to implement various aspects of the present disclosure as described herein.

The terms “program” or “software” are used herein to refer to any type of computer code or set of computer-executable instructions that may be employed to program one or more processors to implement various aspects of the present disclosure as described herein. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium so that the locations convey how the fields are related. However, any suitable mechanism may be used to relate information in fields of a data structure, including through the use of pointers, tags, or other mechanisms that establish how the data elements are related.

Various features and aspects of the present disclosure may be used alone, in any combination of two or more, or in a variety of arrangements not specifically discussed in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

What is claimed is:

1. A method for providing access to content, comprising acts of:
receiving, from a user device, a request for content, the request comprising information indicative of a per-copy identifier associated with a copy of a piece of content;
determining, based on the per-copy identifier associated with the copy of the piece of content, one or more features; and
causing the one or more features determined based on the per-copy identifier to be enabled in a user interface presented by the user device.

2. The method of claim 1, wherein:
the one or more features determined based on the per-copy identifier comprise one or more features selected from a group consisting of: translation, reading level adaptation, audio playback, and display adaptation.

3. The method of claim 2, wherein:
the one or more features determined based on the per-copy identifier comprise display adaptation; and
the display adaptation comprises at least one adaptation selected from a group consisting of: a display layout, a font size, a color filter, and a decode mode.

4. The method of claim 1, where:
the copy of the piece of content comprises a copy of a given edition of the piece of content; and
the method further comprises acts of:
determining whether another edition of the piece of content is available; and
in response to determining that another edition of the piece of content is available, causing the user interface to prompt a user to indicate whether the user wishes to access the other edition of the piece of content.

5. The method of claim 4, wherein:
the other edition is more recent than the given edition.

6. The method of claim 1, further comprising acts of:
determining, based on the per-copy identifier associated with the copy of the piece of content, one or more access rules; and
applying the one or more access rules to determine whether to grant the request for content.

7. The method of claim 6, wherein:
the one or more access rules comprise an access rule based on an item selected from a group consisting of: a network address, a device identifier, a password, and a passkey.

8. The method of claim 1, further comprising acts of:
receiving, from the user device, information relating to one or more interactions of a user with the piece of content; and
updating, based on the one or more interactions, a record associated with the per-copy identifier.

9. The method of claim 8, wherein:
updating the record associated with the per-copy identifier comprises storing, in the record, a score indicating how challenging the user finds the piece of content; and
the score is determined based on the one or more interactions of the user with the piece of content.

10. The method of claim 1, wherein:
the piece of content comprises a piece of writing;
the request further indicates a passage identifier associated with a passage of a plurality of passages in the piece of writing; and
the method further comprises an act of:
causing the user interface to render the passage associated with the passage identifier.

11. A method for providing access to content, comprising acts of:
receiving, from a user device, a request for content, the request comprising information indicative of a passage identifier associated with a passage of a plurality of passages in a piece of writing;
using the passage identifier to obtain text associated with the passage; and
causing the text to be rendered in a user interface presented by the user device.

12. The method of claim 11, wherein:
the passage identifier comprises a passage edition identifier identifying an edition of the passage; and
the text associated with the passage comprises text of the edition of the passage;
the act of using the passage identifier to obtain text associated with the passage comprises:
using the passage identifier to access a data record associated with the edition of the passage; and
obtaining the text of the edition of the passage from the data record.

13. The method of claim 12, wherein:
the edition of the passage comprises an adapted edition of the passage obtained from an original edition of the passage by applying one or more adaptations; and
the one or more adaptations comprise an adaptation in at least one aspect selected from a group consisting of: language, dialect, reading level, and culture.

14. The method of claim 12, the method further comprises acts of:
obtaining audio data of the passage edition from the data record; and
transmitting the audio data to the user device.

15. The method of claim 14, wherein:
the method further comprises an act of transmitting, to the user device, timestamp metadata associated with the audio data;
the timestamp metadata indicates boundaries of at least one linguistic unit in the audio data; and
the at least one linguistic unit is selected from a group consisting of: morpheme, word, phrase, clause, sentence, and paragraph.

16. The method of claim 15, wherein:
the user interface is configured to use the timestamp metadata to synchronize textual display and audio playback.

17. The method of claim 11, wherein:
the request is sent by the user device in response to a user entering, via the user interface, a passage number printed on a hard copy of the piece of writing in a manner that indicates an association with the passage.

18. The method of claim 11, wherein:
the request is sent by the user device in response to a user using the user device to scan a code printed on a hard copy of the piece of writing in a manner that indicates an association with the passage.

19. The method of claim 1, where:
the text associated with the passage comprises text associated with a first edition of the passage and text associated with a second edition of the passage;
the user interface is configured to display, simultaneously, the text associated with the first edition of the passage and the text associated with the second edition of the passage.

20. The method of claim 19, wherein;
the text associated with the first edition of the passage is displayed in a first pane;
the text associated with the second edition of the passage is displayed in a second pane different from the first pane;
the passage comprises a first passage of the plurality of passages of the piece of writing;
the user interface is configured to update the first pane and the second pane simultaneously in response to an input indicating that a user wishes to navigate to a second passage of the plurality of passages, the second passage being different from the first passage;
the first pane is updated to display text associated with a first edition of the second passage; and
the first pane is updated to display text associated with a first edition of the second passage.
